(19) United States
(12) Patent Application Publication
(10) Pub. No.: US 2010/0096258 A1
(43) Pub. Date: Apr. 22, 2010

(54) REDUCED VOLTAGE DROP ANODE ASSEMBLY FOR ALUMINUM ELECTROLYSIS CELL, METHOD OF MANUFACTURING ANODE ASSEMBLIES AND ALUMINUM ELECTROLYSIS CELL

(75) Inventors: Frank Hiltmann, Kriftel (DE); Martin Christ, Augsburg (DE); Werner Langer, Altenmunster (DE); Oswin Öttinger, Meitingen (DE)

Correspondence Address: LERNER GREENBERG STEMER LLP, P O BOX 2480, HOLLYWOOD, FL, 33022-2480, US

(73) Assignee: SGL CARBON SE, Wiesbaden (DE)

(21) Appl. No.: 12/641,758

(22) Filed: Dec. 18, 2009

Related U.S. Application Data
(63) Continuation of application No. PCT/EP2008/057875, filed on Jun. 20, 2008.

(30) Foreign Application Priority Data
Jun. 22, 2007 (EP) 07110910.2

(51) Int. Cl. C25B 9/00; C25B 11/02; B29C 65/00

(52) U.S. Cl. 204/242; 204/286.1; 156/242

(57) ABSTRACT

An anode assembly for aluminum electrolysis cells includes carbon anodes with stubholes and an anode hanger having stubs, in which the anodes are fixed to the anode hanger by cast iron and the stubholes are fully or partially lined with an expanded graphite lining. The anode assembly provides a reduced voltage drop across an interface between the cast iron and the carbon anode and thus increases cell productivity significantly. Mechanical stresses in the stubhole area are reduced. A collar formed from the lining prevents spilling of cast iron over the anode surface and a protective shot plug or a protective collar optionally prevent direct contact of a hot electrolyte bath with the stub and the cast iron. A method of manufacturing anode assemblies and an aluminum electrolysis cell, are also provided.

### CROSS-REFERENCE TO RELATED APPLICATION

This is a continuation, under 35 U.S.C. §120, of copending International Application No. PCT/EP2008/057875, filed Jun. 20, 2008, which designated the United States; this application also claims the priority, under 35 U.S.C. §119, of European Patent Application EP 07 110 910.2, filed Jun. 22, 2007; the prior applications are herewith incorporated by reference in their entirety.

### BACKGROUND OF THE INVENTION

1. Field of the Invention

The invention relates to anode assemblies for aluminum electrolysis cells formed of carbon anode blocks and anode hangers attached to the blocks, in which anode stubholes receiving anode hanger stubs are filled with cast iron sealant. The invention also relates to a method of manufacturing anode assemblies and an aluminum electrolysis cell.

Aluminum is conventionally produced according to the Hall-Heroult process, by the electrolysis of alumina dissolved in cryolite-based molten electrolytes at temperatures up to around 970° C. Hall-Heroult aluminum reduction cells are operated at low voltages (e.g. 4-5 V) and high electrical currents (e.g. 100,000-350,000 A). The high electrical current enters the reduction cell from the top through the anode structure and then passes through the cryolite bath, through a molten aluminum metal pad, enters the carbon cathode block, and then is carried out of the cell by collector bars.

A Hall-Heroult reduction cell typically has a steel shell provided with an insulating lining of refractory material, which in turn has a lining of carbon contacting the molten constituents. Steel-made collector bars connected to the negative pole of a direct current source are embedded in the carbon cathode substrate forming a bottom floor of the cell.

One or more carbon anode blocks are provided above each cathode block and are partly submerged in the cryolite bath. The carbon anodes are manufactured by mixing petroleum coke and pitch, forming the mixture into blocks including stubholes for the electrical connection, and subsequently baking them.

In an electrolysis cell of common size, there are about 20-30 carbon anodes, and since those anodes are consumed gradually, they have to be changed usually within a month, depending on the size of the anodes and amperage applied. Thus, in each cell there is one anode exchanged every day.

The carbon anodes are fixedly connected to anode hangers. The anode hangers serve two different purposes, namely to keep the carbon anodes at a predetermined distance from the cathode, and to conduct the electric current from an anode bar down through the carbon anodes. The anode hangers are fixed to an overhanging anode bar through the use of a clamping device in a detachable manner. As the carbon anodes are gradually consumed and as aluminum metal is removed from the cells, the anode bar, with the carbon anodes attached thereto, is lowered to keep a constant distance between the bottom side of the anodes and the aluminum pad.

Since cell amperage is very high, electric current connections and bus bars are therefore made of industrial metals with good electric conductivity i.e. usually pure copper or aluminum.

Since the lower part of the anode hangers is situated close to the cryolite bath, which is at a high temperature, that part of the anode hanger is made of material which is resistant to the high temperature, usually steel.

An anode hanger is formed of aluminum or copper rods welded or bolted to steel stubs. In order to produce an anode assembly, the cylindrical stubs of the anode hanger are then positioned in the pre-formed conical stubholes of the anodes and molten cast iron is poured around the stubs (which is called “rodding”).

The voltage drop between the stub and the carbon anode is an important part of the overall voltage drop at the anode and has a detrimental impact on the electrolytic process.

Ohmic heat, which is generated due to a high voltage drop at the anode, has a strong thermal effect on the electrolytic bath, and should be minimized. The less heat evolved in the anode, the more heat can be generated in the electrolyte. That allows an increase in anode-cathode distance (ACD), which in turn is favorable when aiming at boosting current density as well as current efficiency. As practical measurements have shown, the stub-to-anode voltage drop is on the same order of magnitude as the average voltage drop in the anode block itself. That effect is even more remarkable when a new anode assembly has just been put into operation. That effect can be attributed to the different thermal expansion coefficients of the steel stub, cast iron and carbon anode.

It was therefore concluded that the potential in reducing the voltage drop between the stub and the carbon anode is greater than in the carbon anode itself.

That problem has been partially addressed in the prior art. For example, German Published, Prosecuted Patent Application DE-AS 1 187 807 discloses a carbon anode having one or more cavities for receiving a metal stub or rod. The surfaces of the cavities have grooves or teeth to increase the surface area which is said to provide better conductivity of the current from the rod into the anode.

Russian Patent 378,524 illustrates a carbon electrode structure having the usual central stubhole to receive a metal stub and also having a series of stubholes drilled into the carbon block parallel to the central stubhole to receive cast iron rods. Openings are then cut into the carbon between the central stubhole and the cast iron rods to permit cast iron bridge pieces to be poured to connect the cast iron rods to the metal stub.

The above-described attempts do provide for a more even current distribution across the upper part of the anode block, but require substantial adjustments to the anode as well as the stub structure and furthermore do not address the substantial voltage losses at the stub-anode interface.

### SUMMARY OF THE INVENTION

It is accordingly an object of the invention to provide a reduced voltage drop anode assembly for an aluminum electrolysis cell, a method of manufacturing anode assemblies and an aluminum electrolysis cell, which overcome the hereinafore-mentioned disadvantages of the heretofore-known assemblies, methods and cells of this general type.

With the foregoing and other objects in view there is provided, in accordance with the invention, anode assemblies comprising carbon anode blocks with stubholes, anode hangers with stubs extended into the stubholes in the anode blocks, expanded graphite fully or partially lining the stubholes, and cast iron fixing the stubs to the anode blocks.

Thus, the anode assemblies for aluminum electrolysis cells according to the invention are formed of carbon anode blocks and anode hangers attached to the blocks, in which anode stubholes receiving anode hanger stubs are lined with expanded graphite. As a consequence, contact resistance between the anode block and the cast iron sealant is reduced, resulting in a reduced voltage drop across that interface. Furthermore, the expanded graphite lining may form a collar providing additional benefits of the present invention.

Expanded graphite (EG) provides good electrical and thermal conductivity, especially with its plane layer. It also provides some softness and good resilience, making it a common material for gasket applications. Those characteristics render it an ideal material to improve the contact resistance between the anode block and the cast iron. The resilience also significantly slows down the increase of the contact voltage drop at the interface between the cast iron and the anode blocks during electrolysis, since it can fill out the gaps formed due to creep of the involved materials. The increase of contact voltage drop at the interface between the cast iron and the anode blocks is further reduced especially by the EG lining at the bottom of the anode stubhole, since it acts as barrier to e.g. aluminum diffusing through the anode block, thus preventing formation of insulating layers at that interface.

Furthermore, the resilience of EG eases mechanical stress due to different coefficients of thermal expansion between the steel stub, the cast iron and the anode block. Thermal expansion of the different materials occurs mainly during pre-operational heating-up of the electrolysis cell and also during rodding and frequently results in cracks in the anode block that further reduce their lifetime.

With the objects of the invention in view, there is also provided a method of manufacturing anode assemblies for aluminum electrolysis cells. The method comprises manufacturing a carbon anode block having stubholes formed therein, lining the stubholes with an expanded graphite lining, providing an anode hanger with downwardly-facing anode hanger stubs, extending each of the stubs into a respective one of the stubholes in the anode block, and fixing the anode hanger to the anode block by pouring cast iron into gaps in the stubholes between the stubs and the anode block.

With the objects of the invention in view, there is concomitantly provided an aluminum electrolysis cell, comprising assemblies according to the invention.

Other features which are considered as characteristic for the invention are set forth in the appended claims.

Although the invention is illustrated and described herein as embodied in a reduced voltage drop anode assembly for an aluminum electrolysis cell, a method of manufacturing anode assemblies and an aluminum electrolysis cell, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a perspective view of an anode hanger onto which a carbon anode is mounted;

FIG. 2 is an enlarged, fragmentary, cross-sectional view of a prior art connection between a stub and a carbon anode;

FIG. 3 is an enlarged, fragmentary, cross-sectional view of a connection according to the invention between a stub and a carbon anode;

FIGS. 4 to 6 are enlarged, fragmentary, cross-sectional views of a connection according to the invention between a stub and a carbon anode, wherein an expanded graphite lining extends above a stubhole, thus forming a collar; and

FIG. 7 is an elevational view of a laboratory test setup for testing a change of contact resistance at a stub-to-anode interface.

### DETAILED DESCRIPTION OF THE INVENTION

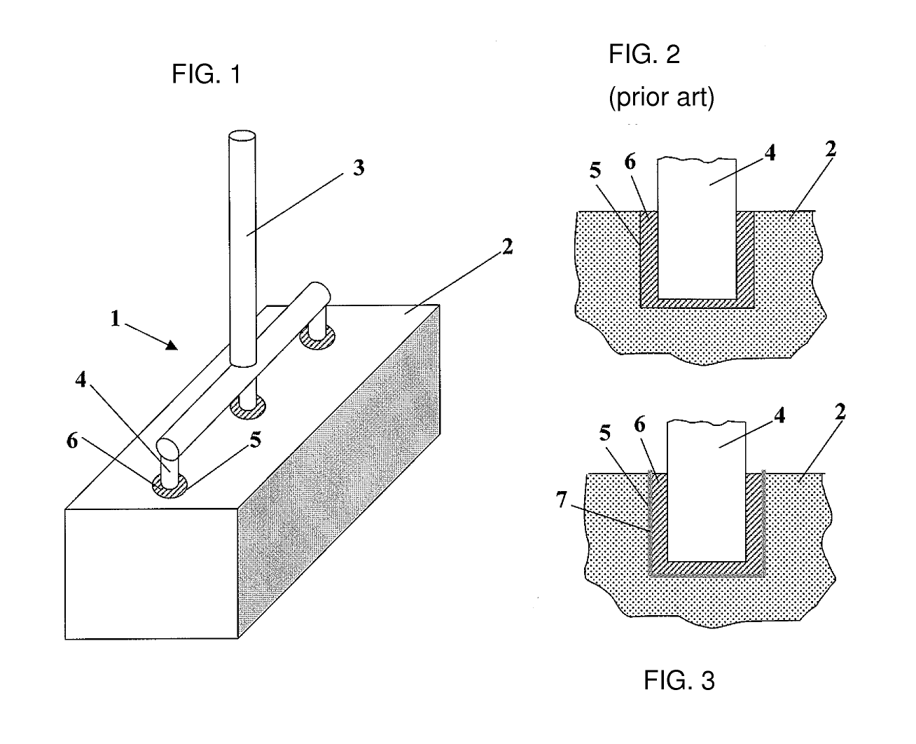

Referring now to the figures of the drawings in detail and first, particularly, to FIG. 1 thereof, there is seen an anode assembly 1 with an anode hanger 3 supporting a carbon anode 2 which is used in cells producing aluminum by electrolysis. Three downwardly-protruding steel stubs 4 of the anode hanger each extend into a respective stubhole 5 of the anode 2 and are fixed there by pouring cast iron 6 into a gap formed between the stub 4 and the anode 2, as shown in FIG. 2.

FIG. 3 shows an anode-stub-connection according to the present invention. The stubhole 5 of the anode 2 is lined with an expanded graphite lining 7 and a gap between the lining 7 and the anode stub 4 is filled with cast iron 6.

The lining 7 may be applied to the entire surface of the carbon anode 2 defined by the stubhole 5. Furthermore, the lining 7 may only be applied to parts of the surface defined by the stubhole 5.

The expanded graphite lining 7 is preferably provided as a thin foil but can also be provided by coating the stubhole 5 with a paste formed of expanded graphite and a hardenable binder, such as phenolic resin. In the latter case, the cast iron 6 is preferably poured into the lined stubhole 5 after the binder has cured. If the lining 7 is formed of graphite foil, it can be attached to the surface defined by the stubhole 5 with a glue. A further advantage of this invention is that the graphite foil may be pre-shaped as a sleeve or a socket prior to the lining to simplify the lining process.

The thickness and density of the lining 7 depends largely on the dimensions and operational parameters of the stubhole 5. In addition to the reduction of the contact resistance, the expanded graphite lining 7 also acts as a barrier against chemical compounds diffusing through the carbon anode or anode block 2 towards the cast iron 6. It also buffers thermomechanical stresses, depending on the specific characteristics of the selected expanded graphite quality.

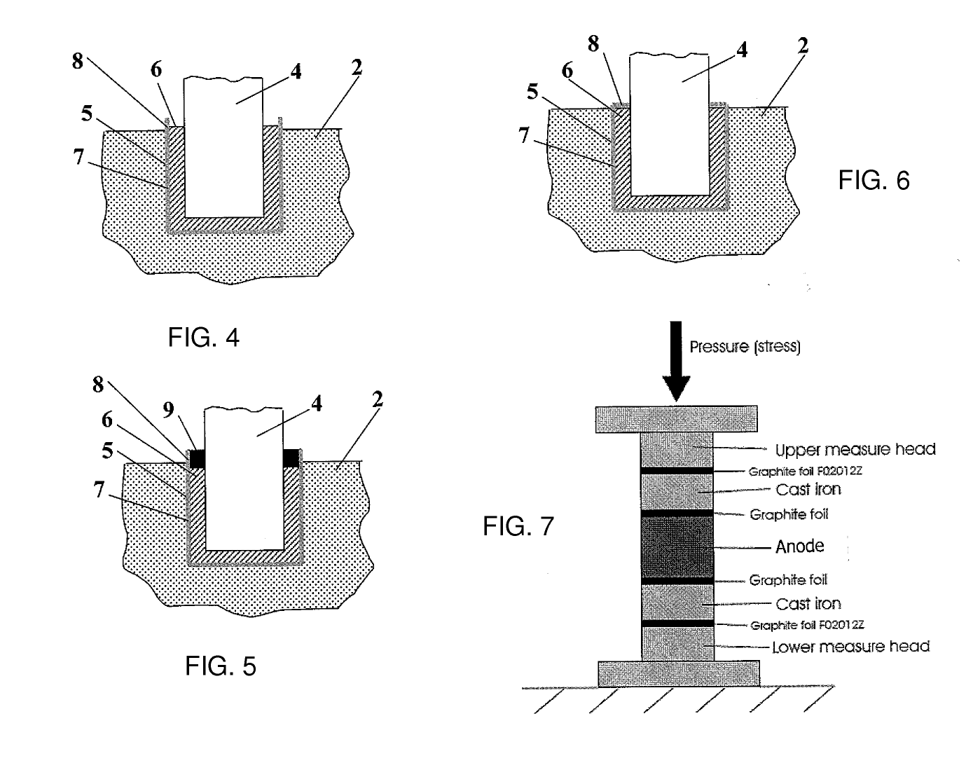

Furthermore, if the lining 7 is based on graphite foil, it may preferably extend above the stubhole 5, thus forming a small collar 8 as seen in FIG. 4. The collar 8 prevents cast iron 6 from being spilled over the surface of the anode 2 during casting. In this manner, used anodes 2 can be more easily detached from the stubs 5 after operational life in the cell.

According to another embodiment of the present invention shown in FIG. 5, a protecting ring can be formed by filling a free space between the collar 8 and the steel stub 4 above the cast iron 6 with carbonaceous paste 9 and finally hardening this paste to form a protective shot plug. This measure prevents the electrolytic bath from coming into contact with the steel stub 4 and the cast iron 6.

According to yet another embodiment of this invention as shown in FIG. 6, sleeves of the expanded graphite collar 8 above the cast iron 6 are simply bent downwards towards the steel stub 4, thus forming a protective collar. This measure prevents the electrolytic bath from coming into contact with the steel stub 4 and the cast iron 6.

The contact resistance between the stub 4 and the carbon anode 2 was determined with a laboratory test device depicted in FIG. 7. The device measured the change of through-plane resistance under load. This test setup was used to mimic the effects of using an expanded graphite lining 7 for lining the stubholes 5. Various types and thicknesses of expanded graphite foil (for example SIGRAFLEX F02012Z) have been tested by using loading/unloading cycles. The specimen size was 25 mm in diameter. The tests were carried out by using a universal testing machine (produced by Frank Prüfgeräte GmbH). The anode specimens were manufactured in the following manner: 100 parts petrol coke with a grain size from 12 μm to 7 mm were mixed with 25 parts pitch at 150° C. in a blade mixer for 10 minutes. The resulting mass was extruded into blocks of the dimensions 700×500×3400 mm (width×height×length). These so-called green blocks were placed in a ring furnace, covered by metallurgical coke and heated to 900° C. Afterwards, small specimen pieces were cut from the block.

A comparison of test curves revealed a significant decrease (by over 20%) in through-plane resistance, especially at lower loadings, by the system according to the invention with expanded graphite. This advantage is also maintained upon load relaxation due to the resilience of the expanded graphite.

It was thus shown that the invention described herein can significantly contribute to lowering the voltage drop at the anodes 2 of aluminum electrolysis cells.

Having thus described the presently preferred embodiments of our invention, it is to be understood that the invention may be otherwise embodied without departing from the spirit and scope of the following claims.

1. An anode assembly for aluminum electrolysis cells, the anode assembly comprising:
carbon anodes having stubholes formed therein;
an expanded graphite lining at least partially lining said stubholes;
an anode hanger having stubs protruding into said stubholes; and
cast iron fixing said stubs in said stubholes to said anodes.

2. The anode assembly according to claim 1, wherein said expanded graphite lining is formed of graphite foil.

3. The anode assembly according to claim 2, wherein said expanded graphite foil is pre-shaped as a sleeve or socket.

4. The anode assembly according to claim 1, wherein said expanded graphite lining is formed of a paste of expanded graphite and a hardenable binder.

5. The anode assembly according to claim 4, wherein said hardenable binder is phenolic resin.

6. The anode assembly according to claim 2, wherein said expanded graphite lining extends above said stubhole to form a collar.

7. The anode assembly according to claim 3, wherein said expanded graphite lining extends above said stubhole to form a collar.

8. The anode assembly according to claim 6, wherein said collar forms a free space within said collar above said cast iron, and a carbonaceous paste fills said free space.

9. The anode assembly according to claim 7, wherein said collar forms a free space within said collar above said cast iron, and a carbonaceous paste fills said free space.

10. The anode assembly according to claim 7, wherein said sleeve of said expanded graphite collar above said cast iron is bent downwards towards said stub to form a protective collar.

11. A method of manufacturing anode assemblies for aluminum electrolysis cells, the method comprising the following steps:
manufacturing a carbon anode block having stubholes formed therein;
lining the stubholes with an expanded graphite lining;
providing an anode hanger with downwardly-facing anode hanger stubs;
extending each of the stubs into a respective one of the stubholes in the anode block; and
fixing the anode hanger to the anode block by pouring cast iron into gaps in the stubholes between the stubs and the anode block.

12. An aluminum electrolysis cell, comprising assemblies according to claim 1.
